(19) United States
(12) Patent Application Publication
(10) Pub. No.: US 2010/0192892 A1
(43) Pub. Date: Aug. 5, 2010

(54) Hybrid valve for internal combustion engines

(76) Inventor: Reggie Dwayne Huff, Warren, OH (US)

Correspondence Address: Xcentrick Innovations, Inc., 2785 Timbercreek Drive, Cortland, OH, 44410, US

(21) Appl. No.: 12/322,074

(22) Filed: Jan. 30, 2009

(51) Int. Cl. F16K 1/00

(52) U.S. Cl. 123/188.3

(57) ABSTRACT

A next generation hybrid valve concept for enhanced induction cycle function for internal combustion engines. Said hybrid valve effectively combining automatic pressure activated check valve function with traditional poppet valve function to create an effective low cost self regulating variable valve timing (VVT) system. Said hybrid valve consisting of a free floating annular ring seal which is affixed concentrically around a modified poppet valve seat or within an engine head seat insert configured with releasably sealable jet flow passage ways.

The concept can provide an effective range of late opening and early closing times to control reversion as well as a very broad range of early opening and late closing times. In addition, the actuation of the free floating ring seal is variable, automatic and controlled and timed very precisely by cycle exchange functions allowing for effective variable valve function in four (4) dimensions within single cylinder engines and five (5) dimensions within multi-cylinder engines.

### BACKGROUND

The invention here disclosed relates primarily to a reciprocating intake valve and/or engine head seat insert controlling the movement of air or air/fuel mixture into the combustion chamber (cylinder) of internal combustion engines.

In typical internal combustion engines the intake valves and the engine head seat inserts are of a single piece construction and are incapable of varying their opening and/or closing events independent of typical valve control mechanisms.

Since the efficiency and timing of this valve arrangement is a major factor in the performance of the entire engine, there have been many attempts at improving the mechanical motion of valves to maximize the flow dimension (volume) of the typical valve and port arrangement. Further, since the timing of these valve arrangements is an important factor in the performance of internal combustion engines, many attempts to vary the timing of the displacement of intake and, to a much lesser extent, exhaust valves in relation to their respective ports in relation to engine speed and load, and atmospheric conditions have been explored.

Increasing the flow dimension allowed by the valve and port arrangement increases the power (output) of the engine. Varying the timing of valve to port opening and closing events in relation to engine speed, engine load, and atmospheric conditions also increases the power as well as the fuel efficiency, and reduces the environmentally harmful emissions of internal combustion engines. In addition, the idle performance, low speed operational control, and cold starting performance and emissions, etc., can all be dramatically improved relative to increased peek output.

It is toward these fundamental factors of improved flow dimension (volume) and constant variable valve to port timing that the here disclosed invention takes a giant step forward by accomplishing both at the same time, while minimizing current engine design intrusiveness.

It is further the intent of the here disclosed invention(s) to address various deficiencies, compromises, and other important factors revealed through the study of early design attempts to accomplish similar advantages. The most intriguing and promising being that disclosed in U.S. Pat. No. 3,903,855 to Klakulak et al, and assigned to General Motors Corporation, and U.S. Pat. No. 4,094,277 to Goto et al, and assigned to the Toyota Corporation. These early designs integrate an “auxiliary” inlet valve structure, which is operated and controlled by pressure differentials during the inlet cycle. The auxiliary inlet valve is designed to effectively allow flow in one direction. While these inventions would allow for improved effective valve timing at low engine speeds their structure would also reduce the flow dimension of the inlet conduit primarily at mid to high engine speeds.

In addition, these designs require the mass and the displacement range of the auxiliary valve to be excessive, creating excessive inertia potential during normal operating conditions. This inertia potential requires excessive spring biases to be applied to the auxiliary valve, which severely limits the flow potential of the inlet conduit and/or effective back-flow restriction and response timing.

It is further recognized by the present invention that the early designs are excessively complex. This further complicates manufacture and implementation of the invention as well as increases costs unnecessarily.

Further, the hybrid valve design disclosed by Huff in U.S. Pat. No. 6,659,059 utilizes an auxiliary variable displacement seat structure that limits effective variable valve timing to those that are shorter then the base cam timings but nonetheless has repeatedly shown useful enhanced engine function.

It is the object of the here disclosed invention to significantly enhance the commercial acceptability of previously recognized hybrid valve design concepts by demonstrating improvements in fundamental areas including most notably performance by allowing an effective range of variable valve timings both longer and shorter then the base cam timing and longevity by greatly reducing the mass and stress associated with the free floating ring seal element.

It is further the object of this invention to allow reduced overall valve and related valve train component stress compared to current levels and allow for the use of lower cost key component material such as aluminum which may now be a suitable material for the ring seal.

Through testing it has been determined that manifold pressure at idle and low throttle positions can be excessively diminished due to extremely efficient cycling. Excessively low manifold pressure can cause oil to bypass piston rings and/or intake valve guide seals. In such instances, manifold pressure regulated exhaust gas recirculation (EGR) or EGR augmented manifold pressure can be employed to not only solve the low manifold pressure problem but actually increase manifold pressure over standard reducing pumping losses, increasing efficiency and aid in reducing cold start as well as overall emissions. A less desirable solution is to simply adjust base cam timing at a measurable cost to the efficiency gains available through manifold pressure regulated EGR or EGR augmented manifold pressure.

Further clarification of the advantages and features of the present invention(s) is provided within the specification.

### BRIEF SUMMARY OF INVENTION

This invention relates primarily to engine valves, and, in particular, the reciprocating valves necessary for the intake of air or air/fuel mixture (atmosphere) into the combustion chambers of conventional internal combustion engines.

In order to obtain the maximum power output and efficiency of conventional internal combustion engines it is necessary to maximize the flow dimension of the atmosphere to and from the combustion chamber at all speed and load conditions. The traditionally accepted method used to attempt this is by use of single stage (function) reciprocating intake and exhaust valves actuated by a cam transferring a predetermined displacement sequence motion to a rocker arm that transfers its motion to the tip of the valve stem, controlling the valve's displacement and timing.

Due to the mechanical limitations of this traditional method, lengthy initial opening and final closing events are necessary to dampen the valve's opening and closing action. This condition has a particularly negative effect on the low to mid-speed performance, fuel economy, and emissions of typical internal combustion engines. These mechanical limitations also limit the phase timing, lift, duration, rate of lift, and all timing dimensions relative to associated (co-joined) cylinders to one single static timing for all valves relative to all cylinders at all times and in all conditions relative to crankshaft angle. This forces the engine designer to accept compromises that have a negative effect on engine performance, fuel economy, and emissions, at virtually all speed and load settings.

The invention disclosed herein adds effective intake check valve function to the traditional poppet valve function that automatically, independently, and extremely rapidly varies its displacement or position relative to the intake valve, to either enhance or constrain the flow of atmosphere to or from the combustion chamber in direct response to engine speed, load, and ambient atmospheric conditions.

In the preferred embodiments the intake valve or engine head seat insert is designed with an auxiliary annular ring seal which acts as an independent check valve and is designed to be linked concentrically around the outer circumference of the intake valve head or a select inboard circumference of engine head seat insert. The annular ring seal and valve arrangements are designed to allow the ring seal to alter its displacement relative to the displacement of the intake valve base (head) or engine head seat insert coaxially for a predetermined displacement range while not allowing disengagement of the ring seal.

In all cases the ring seals actuation and displacement is dependent of pressure differentials created between the cylinder and the respective intake and exhaust ports during the normal operation of an internal combustion engine.

The independent control and displacement of the ring seal(s) allows each engine cylinder to time its actuation with its own independent flow demand and timing, which varies throughout a wide spectrum of speed versus load conditions. This allows for increases in overall performance and efficiency of single to multi-cylinder internal combustion engines over a broad range of conditions and applications.

### BRIEF DESCRIPTION OF DRAWINGS

FIG. 1 is a sectional side view of an engine head seat insert in orientation with a modified poppet valve head including an interrupted seat with jet flow passage ways (channels) and including a sectional side view of a ring seal arrangement.

FIG. 2 is a sectional side view of an engine base (head) seat insert in orientation with a sectional side view modified poppet intake valve head including an interrupted seat with jet flow passage ways and including a sectional side view of a ring seal arrangement depicted in both open and closed positions.

FIG. 3 is a top view of a ring seal embodiment.

FIG. 4 is a split sectional side view of the ring seal embodiment depicted in FIG. 3.

FIG. 5 is a side view of a modified poppet valve base in orientation with sectional side view engine seat insert including an interrupted seat with jet flow passage ways and including a sectional side view of a corresponding ring seal arrangement.

FIG. 6 is a sectional side view of a modified and self contained engine head seat insert including integral and self contained vents and a sectional side view of a corresponding ring seal arrangement all in orientation with a typical poppet valve head.

FIG. 7 is a sectional side view of an engine head seat insert in orientation with a sectional side view modified poppet intake valve head including an uninterrupted seat with integral and self contained jet vents and including a sectional side view of a ring seal arrangement depicted in both open and closed positions.

FIG. 8 is a partially sectionalized side view of a self contained poppet valve head including integral and self contained vents and a sectional side view of a corresponding ring seal valve arrangement.

### DETAILED DESCRIPTION OF PREFERRED EMBODIMENTS

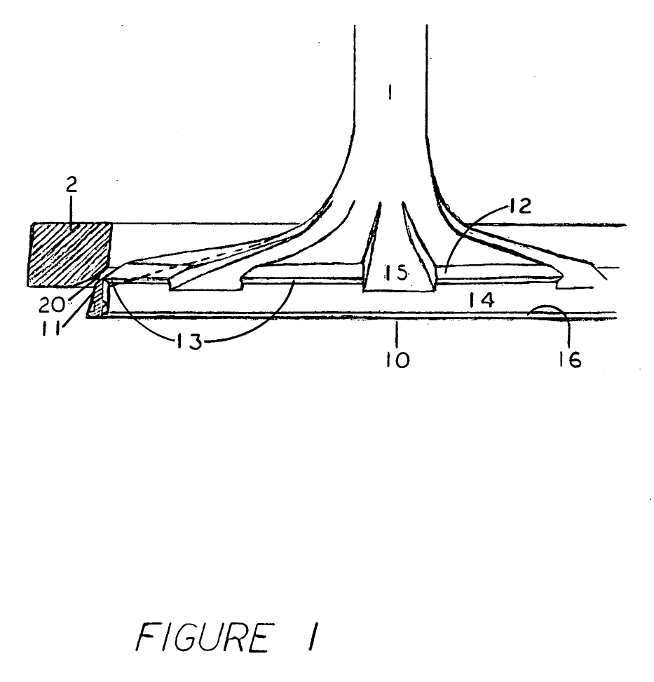

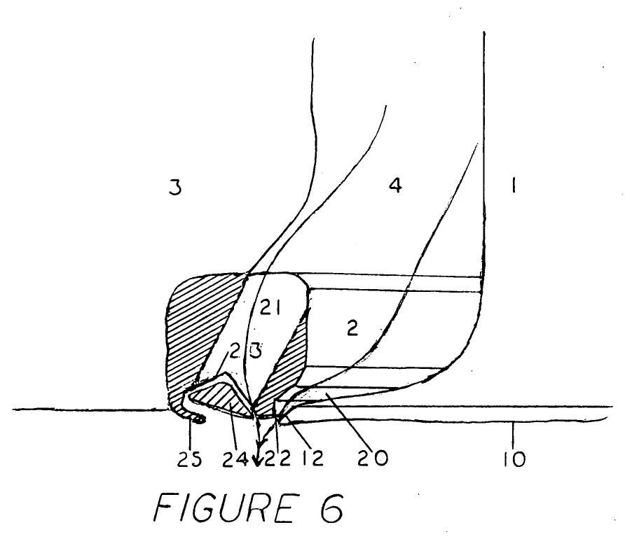

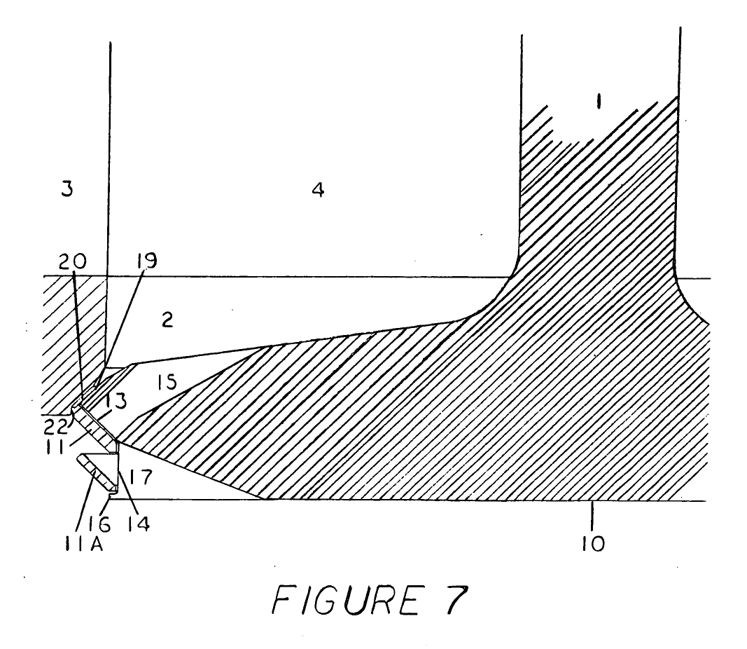

As illustrated by FIGS. 1, 2, 5 & 6, the intake valve, #1, is arranged within a typical internal combustion engine to releasably seal an intake port, FIG. 6-#4. The intake valve includes a valve base (head), FIG. 1, 2, 5 & 6-#10, which, in one preferred embodiment, is specially formed to accept an auxiliary annular ring seal, #11, around the outer periphery of the intake valve base, FIG. 1, 2, 5 & 6-#10.

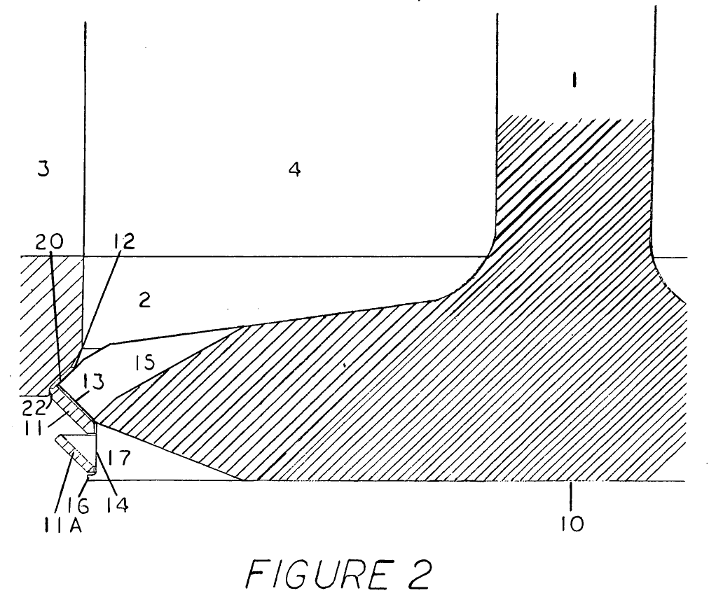

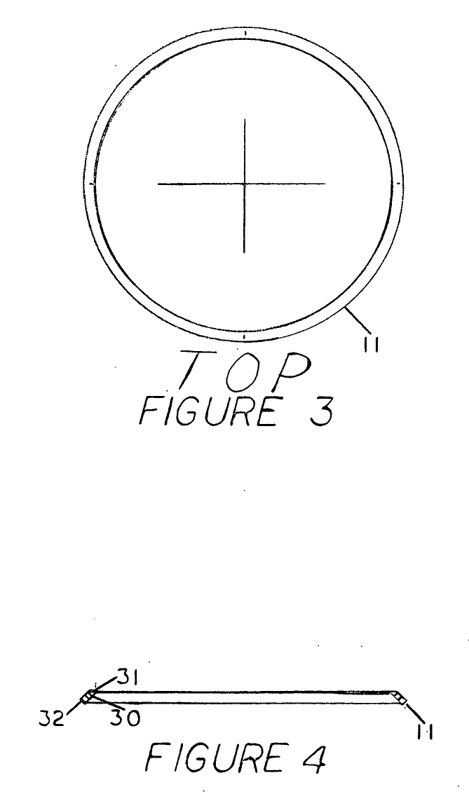

As depicted in FIGS. 1 & 2 the intake valve base #10, is designed with jet flow passage ways #15, evenly spaced around the outer periphery of the main valve head #10, which creates an interrupted main base seat #12. An annular ring seal #11, is configured so as to allow its controlled linear coaxial displacement in line with the main intake valve stem, #1, to a predetermined limit by means of a guide margin FIG. 1-#14. The annular ring seal #11, is configured with an angular seating surface FIG. 4-#30, designed to engage and mate with an inverted interrupted seat #13, and an angular seating surface #32, designed to engage and mate with the engine head seat insert FIG. 1, 2 & 5-#20. When the said ring seal FIG. 2-#11, is pressed into sealing service at its closed terminally displaced position FIG. 2-#11 the said mating surfaces effectively seal the jet flow passage ways FIG. 2-#15, to disallow the flow of atmosphere through the said passage ways FIG. 2-#15.

The intake valve base includes an outside angled seating surface, FIG. 1, 3 & 5-#12, which corresponds with an inside angled seating surface within the engine head seat insert, FIG. 1, 2 & 5-#20. The annular ring seal includes an outside seating surface, FIG. 4-#32, which corresponds with an angled seating surface at the terminal end of the intake port via the engine head seat insert FIG. 1, 2 & 5-#20. In the preferred embodiments, ring seal operation is constrained within the maximum thermally conductive region available.

As illustrated in FIG. 2 the ring seal valve #11, is configured to allow free linear coaxial displacement between the fully mated and closed position #11, and the fully open position #11A. The annular ring seal #11 is retained in operational marriage with the main valve base #10, by means of a retainer tab #16 and guided through out its free linear displacement range by a guide margin as illustrated in FIG. 1-#14.

As illustrated in FIGS. 1 & 2 auxiliary jet flow passage ways FIG. 2-#17, can be configured within the guide margin FIG. 1-#14 as part of the combustion chamber face side #10 of the main poppet valve base to allow additional flow dimension through the main jet flow passage ways FIG. 2-#15 when the annular ring seal valve is displaced to its open position FIG. 2-#11A.

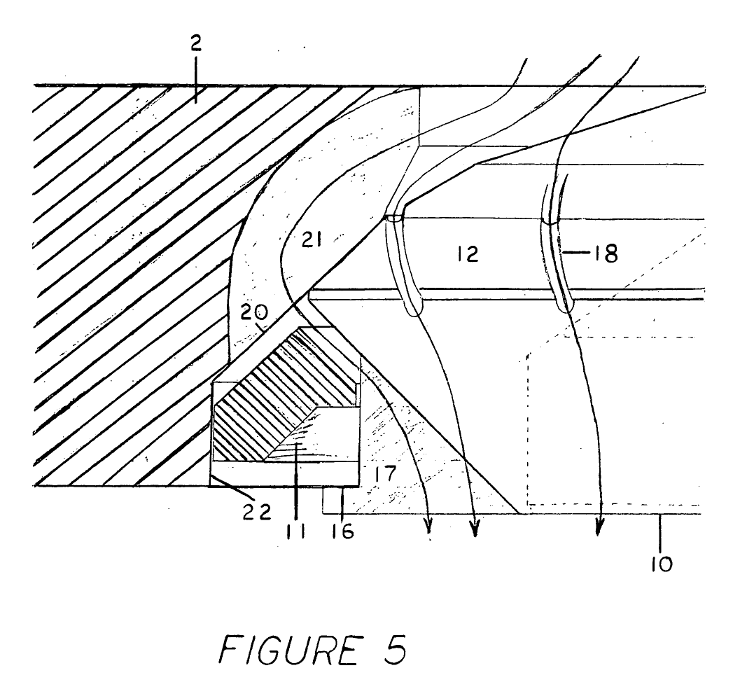

As illustrated in FIGS. 2, 5 & 6-#22, the engine head seat insert #2 can be configured to allow a predetermined counter sink displacement of the entire hybrid valve arrangement within a close dimensional concentric recessed pocket machined into the engine head seat insert.

As illustrated in FIG. 5 jet flow passage ways #21, can be configured upon the inner circumference of the engine head seat insert #21, creating an interrupted seat releasably sealable by an annular ring seal #11. Swirl inducing shallow groves #18, can be configured within the main valve base's #10, main seat #12, releasably sealable by an annular ring seal #11.

As illustrated in FIG. 6 vent openings #21, can be configured to be internally integrated and self contained within the engine base #3, seat insert #2. In this alternative configuration the annular ring seal #24 is completely independent of the main valve base #10 and is designed to releasably seal said integral vent openings #21. Said annular ring seal is retained in operational marriage with the modified engine head seat insert #2, by means of a retainer tab #25. The depicted engine head seat insert modifications are all feasible in less preferred application to integral engine head seat arrangements where the engine head main poppet valve seat modifications are machined directly into the engine head material itself.

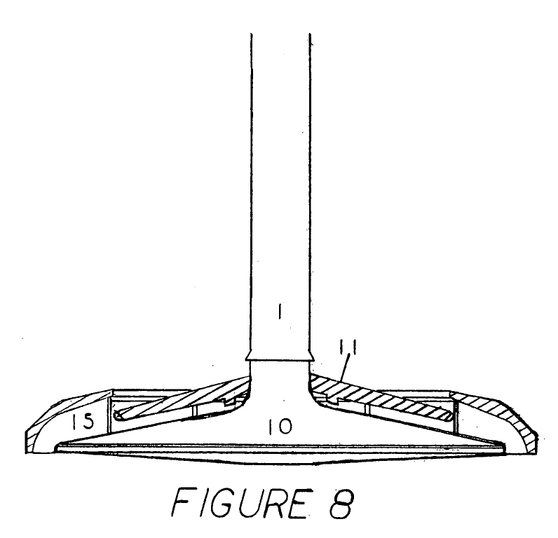

As illustrated in FIG. 7 vent openings #15, can be configured to be internally integrated and self contained within the poppet intake valve base #10, creating an uninterrupted seat #19. In this alternative configuration the annular ring seal #11 can effectively releasably seal said integral vents #15, independent of engagement with the engine head insert seat #20. The annular ring seal #11, is retained in operational marriage with the main valve head #10, by means of a retainer tab #16.

As illustrated in FIG. #8 a less preferred alternative embodiment is depicted where integral vent openingss #15, and a corresponding annular ring seal #11, are all self contained upon the under face side of the main valve base #10.

What is claimed is:

1. A combination poppet and check valve assembly effective for creating automatic variable control of the cycle induced directional flow of liquid and/or gaseous phase molecules through the intake or exhaust port(s) of an internal combustion engine, said valve assembly comprising:
a. A poppet valve means including a stem a base and a main base seat configured to allow linear releasable sealed contiguously mated engagement with a concentrically corresponding engine head seat and a means defining at least one integral vent opening through the said poppet valve base for communicating a passage between a cylinder and at least one engine port;
b. a freely displaceable annular ring seal valve means in orientation with said poppet valve base to allow automatic variably selective opening, closing and sealing of the said integral vent(s) opening;
c. a locked engagement means designed to lock the said annular ring seal valve means into releasably sealable engagement with said poppet valve base means, said locked engagement means designed to allow controlled linear coaxial displacement of said annular ring seal means to a predetermined limit; and
d. a annular ring seal valve guide margin means defining the outer periphery sub-margin of the said poppet valve base configured proximately beneath and inboard of said main base seat means to effectively guide the said ring seal's predetermined linear coaxial displacement within a thermally conductive region and to maintain said ring seal in proper concentric alignment with said poppet valve base means.

2. The combination poppet and check valve assembly in claim 1 including a predetermined counter sink displacement poppet valve seating means within a close dimensional concentrically recessed pocket machined into the said engine head seat means.

3. The combination poppet and check valve assembly in claim 1 wherein the annular ring seal valve is formed of an aluminum alloy material.

4. The combination poppet and check valve assembly in claim 1 utilized in conjunction with engine manifold pressure regulated exhaust gas recirculation (EGR) or EGR augmented manifold pressure.

5. The combination poppet and check valve assembly in claim 1 utilized in conjunction with standard engine poppet valve arrangements including a predetermined counter sink displacement poppet valve seating means within a close dimensional concentrically recessed pocket machined into their respective engine head seat means within the same or dissimilar cylinder.

6. The combination poppet and check valve assembly in claim 1 including a means defining at least one auxiliary jet flow passage way configured cut out of and within the said guide margin as part of the main poppet valve base.

7. A combination poppet and check valve assembly effective for creating automatic variable control of the cycle induced directional flow of liquid and/or gaseous phase molecules through the intake or exhaust port(s) of an internal combustion engine, said valve assembly comprising:
a. A poppet valve means including a stem a base and a main base seat configured to allow linear releasable sealed contiguously mated engagement with a concentrically corresponding engine head seat;
b. an engine head valve seat means configured to allow linear releasable contiguously mated engagement with said poppet valve main base seat;
c. a poppet valve main base seat means or engine head seat means including a means defining at least one jet flow channel cut into and interrupting the concentrically circular mating surface of the said seat means so as to affect unsealable engagement between both said seat means and for communicating a passage between a cylinder and at least one engine port;
d. a freely displaceable annular ring seal valve means in orientation with said poppet valve base to allow automatic variably selective opening, closing and sealing of the said jet flow channel(s); and
e. a locked engagement means designed to lock the said annular ring seal valve means into releasably sealable engagement with said poppet valve base means, said locked engagement means designed to allow controlled linear coaxial displacement of said annular ring seal means to a predetermined limit.

8. The combination poppet and check valve assembly in claim 7 including a predetermined counter sink displacement poppet valve seating means within a close dimensional concentrically recessed pocket machined into the said engine head seat means.

9. The combination poppet and check valve assembly in claim 7 wherein the annular ring seal valve is formed of an aluminum alloy material.

10. The combination poppet and check valve assembly in claim 7 utilized in conjunction with engine manifold pressure regulated exhaust gas recirculation (EGR) or EGR augmented manifold pressure.

11. The combination poppet and check valve assembly in claim 7 utilized in conjunction with standard engine poppet valve arrangements including a predetermined counter sink displacement poppet valve seating means within a close dimensional concentrically recessed pocket machined into their respective engine head seat means within the same or dissimilar cylinder.

12. The combination poppet and check valve assembly in claim 6 including a poppet valve main base seat means and engine head seat means each including a means defining at least one jet flow channel cut into and interrupting the concentrically circular mating surface of the said seat means so as to affect unsealable engagement between both said seat means and for communicating a passage between a cylinder and at least one engine port.

13. The combination poppet and check valve assembly in claim 7 including a poppet valve main base seat means and engine head seat means each including a means defining at least one jet flow channel cut into and interrupting the concentrically circular mating surface of the said seat means so as to affect unsealable engagement between both said seat means and for communicating a passage between a cylinder and at least one engine port wherein each said respective jet flow channel is cut at a cross port axis angle.

14. The combination poppet and check valve assembly in claim 7 including a poppet valve main base seat means and engine head seat means each including a means defining at least one jet flow channel cut into and interrupting the concentrically circular mating surface of the said seat means so as to affect unsealable engagement between both said seat means and for communicating a passage between a cylinder and at least one engine port wherein each said respective jet flow channel is cut at a cross port axis angle in the opposite direction to the other.

15. The combination poppet and check valve assembly in claim 7 including an annular ring seal guide margin and a means defining at least one auxiliary jet flow passage way cut out of and within the said guide margin as part of the main poppet valve base.

16. A combination poppet and check valve assembly effective for creating automatic variable control of the cycle induced directional flow of liquid and/or gaseous phase molecules through the intake or exhaust port(s) of an internal combustion engine, said valve assembly comprising:
a. A poppet valve means including a stem a base and a main base seat configured to allow linear releasable sealed contiguously mated engagement with a concentrically corresponding engine head seat;
b. an engine head valve seat means configured to allow linear releasable contiguously mated engagement with said poppet valve main base seat including a main body constructed of material substantial enough to support said poppet valve's releasable engagement and a means defining at least one integral vent opening through the said main body for communicating a passage between a cylinder and at least one engine port;
c. a freely displaceable annular ring seal valve means in orientation with said engine head seat means to allow automatic variably selective opening, closing and sealing of the said integral vent(s) opening; and
d. a locked engagement means designed to lock the said annular ring seal valve means into releasably sealable engagement with said engine head valve seat means, said locked engagement means designed to allow controlled linear coaxial displacement of said annular ring seal means to a predetermined limit.

17. The combination poppet and check valve assembly in claim 16 including a predetermined counter sink displacement poppet valve seating means within a close dimensional concentrically recessed pocket machined into the said engine head seat means.

18. The combination poppet and check valve assembly in claim 16 wherein the annular ring seal valve is formed of an aluminum alloy material.

19. The combination poppet and check valve assembly in claim 16 utilized in conjunction with engine manifold pressure regulated exhaust gas recirculation (EGR) or EGR augmented manifold pressure.

20. The combination poppet and check valve assembly in claim 16 utilized in conjunction with standard engine poppet valve arrangements including a predetermined counter sink displacement poppet valve seating means within a close dimensional concentrically recessed pocket machined into their respective engine head seat means within the same or dissimilar cylinder.
